(19) United States
(12) Patent Application Publication
(10) Pub. No.: US 2025/0299081 A1
(43) Pub. Date: Sep. 25, 2025

(54) NON-RECIPROCAL CIRCUIT ELEMENT AND QUANTUM COMPUTER

(71) Applicant: TDK Corporation, Tokyo (JP)

(72) Inventors: Takekazu YAMANE, Tokyo (JP); Yoshiaki SATO, Tokyo (JP); Hidenori OHATA, Tokyo (JP)

(73) Assignee: TDK Corporation, Tokyo (JP)

(21) Appl. No.: 19/083,675

(22) Filed: Mar. 19, 2025

(30) Foreign Application Priority Data
Mar. 21, 2024 (JP) 2024-044883

(51) Int. Cl. G06N 10/40; H01P 1/36; H01P 1/38

(52) U.S. Cl. CPC G06N 10/40; H01P 1/36; H01P 1/38

(57) ABSTRACT

A non-reciprocal circuit element includes a housing, first and second units, a ground conductor, and first and second magnets. The first and second units, the ground conductor, and the first and second magnets are housed in the housing, the ground conductor is located between the first and second units, the first and second magnets have the first unit, the ground conductor, and the second unit disposed therebetween, each of the first and second units include a conductor, first and second magnetic bodies, and first and second absorbing bodies, the conductor has first and second terminals, and in each of the first and second units, a first region of conductor which extends between the first and second terminals is sandwiched between the first and second magnetic bodies and a second region which is different from the first region of the conductor is sandwiched between the first and second absorbing bodies.

### BACKGROUND

### Field

The present disclosure relates to a non-reciprocal circuit element and a quantum computer. Priority is claimed on Japanese Patent Application No. 2024-044883, filed Mar. 21, 2024, the content of which is incorporated herein by reference.

### Description of Related Art

Non-reciprocal circuit elements are elements which determine a direction in which high-frequency signals are transmitted. Isolators and circulators are examples of non-reciprocal circuit elements. Non-reciprocal circuit elements are widely used in circuits through which high frequency signals are transmitted.

Non-reciprocal circuit elements are used in a variety of places in which high frequency signals are used. For example, Patent Document 1 discloses an isolator for microwave communication. Furthermore, for example, Patent Document 2 describes the use of an isolator in a quantum computer.

### PATENT DOCUMENTS

[Patent Document 1] Japanese Unexamined Patent Application, First Publication No. H4-287403

[Patent Document 2] Japanese Patent No. 6998459

### SUMMARY

A non-reciprocal circuit element is disposed on a signal line connected to a quantum processor which controls a quantum computer. The quantum processor is disposed in a freezing chamber and a volume of the freezing chamber is limited. For this reason, there is a demand for a small non-reciprocal circuit element. Furthermore, the non-reciprocal circuit element selectively propagates a signal. Suppressing the degradation of signal quality is required even when the size of the non-reciprocal circuit element is reduced.

The present disclosure was made in light of the above circumstances, and an object of the present disclosure is to provide a non-reciprocal circuit element and a quantum computer which have high integration and excellent signal quality.

The present disclosure provides the following means for achieving the above object.

A non-reciprocal circuit element according to a first aspect includes a housing, a first unit, a second unit, a ground conductor, a first magnet, and a second magnet. The first unit, the second unit, the ground conductor, the first magnet, and the second magnet are housed in the housing, the ground conductor is located between the first unit and the second unit, the first magnet and the second magnet have the first unit, the ground conductor, and the second unit disposed therebetween, each of the first unit and the second unit includes a conductor, a first magnetic body, a first absorbing body, a second magnetic body, and a second absorbing body, the conductor has a first terminal and a second terminal, and in each of the first unit and the second unit, a first region of conductor which extends between the first terminal and the second terminal is sandwiched between the first magnetic body and the second magnetic body and a second region which is different from the first region of the conductor is sandwiched between the first absorbing body and the second absorbing body.

A non-reciprocal circuit element relating to the present disclosure has high integration and excellent signal quality.

### BRIEF DESCRIPTION OF THE DRAWINGS

FIG. 1 is a perspective view of a non-reciprocal circuit element according to a first embodiment.

FIG. 2 is a cross-sectional view of the non-reciprocal circuit element according to the first embodiment.

FIG. 3 is a plan view of a conductor and a lossy layer of the non-reciprocal circuit element according to the first embodiment. FIG. 4 is a plan view of the conductor of the non-reciprocal circuit board according to the first embodiment.

FIG. 5 is a plan view of the lossy layer of the non-reciprocal circuit board according to the first embodiment.

FIG. 6 is a schematic diagram of a quantum computer according to the first embodiment.

FIG. 7 is a cross-sectional view of a non-reciprocal circuit element according to a second embodiment.

FIG. 8 is a cross-sectional view of a non-reciprocal circuit element according to a third embodiment.

FIG. 9 is a cross-sectional view of a non-reciprocal circuit element according to a fourth embodiment.

FIG. 10 is a cross-sectional view of a non-reciprocal circuit element according to a fifth embodiment.

FIG. 11 is a cross-sectional view of a non-reciprocal circuit element according to a sixth embodiment.

FIG. 12 is a perspective view of the non-reciprocal circuit element according to the sixth embodiment.

FIG. 13 is a cross-sectional view of a non-reciprocal circuit element according to a seventh embodiment.

FIG. 14 is a cross-sectional view of a non-reciprocal circuit element according to an eighth embodiment.

### DESCRIPTION OF EMBODIMENTS

The present embodiment will be described in detail below with reference to the drawings as appropriate. The drawings used in the following description may show characteristic portions in an enlarged scale for the sake of convenience in order to make the characteristics easier to understand in many cases and the dimensional ratios and the like of each constituent element may differ from the actual ones. The materials, the dimensions, and the like which are exemplified in the following description are merely examples and the present disclosure is not limited to them and can be appropriately modified and implemented within the scope of the effects of the present disclosure.

First, directions are defined. A direction of a surface on which a conductor extends is called an x direction. For example, a direction in which a first terminal T1 and a second terminal T2 of the conductor are connected is defined as the x direction. Furthermore, on the surface on which a conductor extends, a direction which is orthogonal to the x direction is defined as a y direction. A direction which is orthogonal to the x direction and the y direction is defined as a z direction. A stacking direction is an example of the z direction.

### First Embodiment

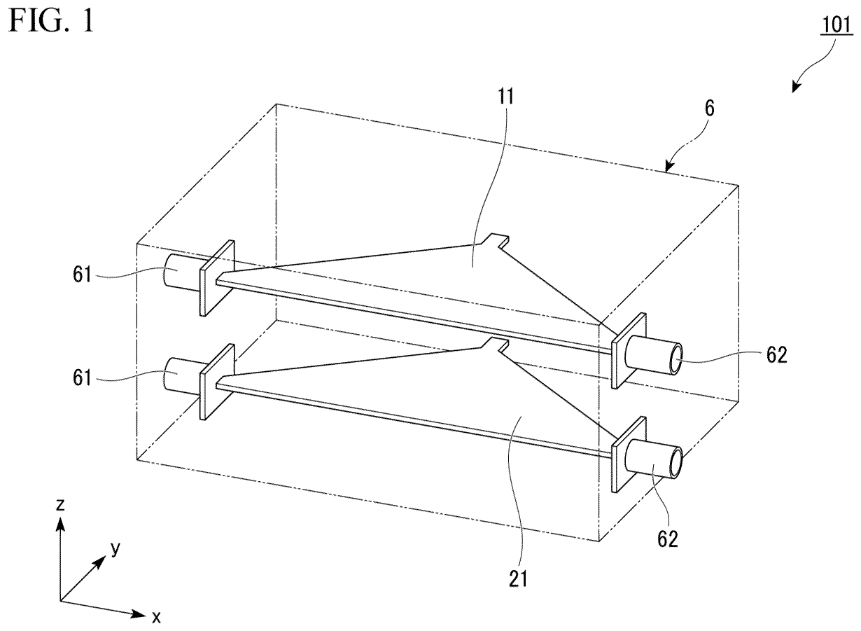

FIG. 1 is a perspective view of a non-reciprocal circuit element 101 according to a first embodiment. The non-reciprocal circuit element 101 is packaged using a housing 6. The housing 6 has an input terminal 61 and an output terminal 62. Each of the input terminal 61 and the output terminal 62 is, for example, connected to each unit inside the housing 6. In FIG. 1, only conductors 11 and 21 among the units inside the housing 6 are shown.

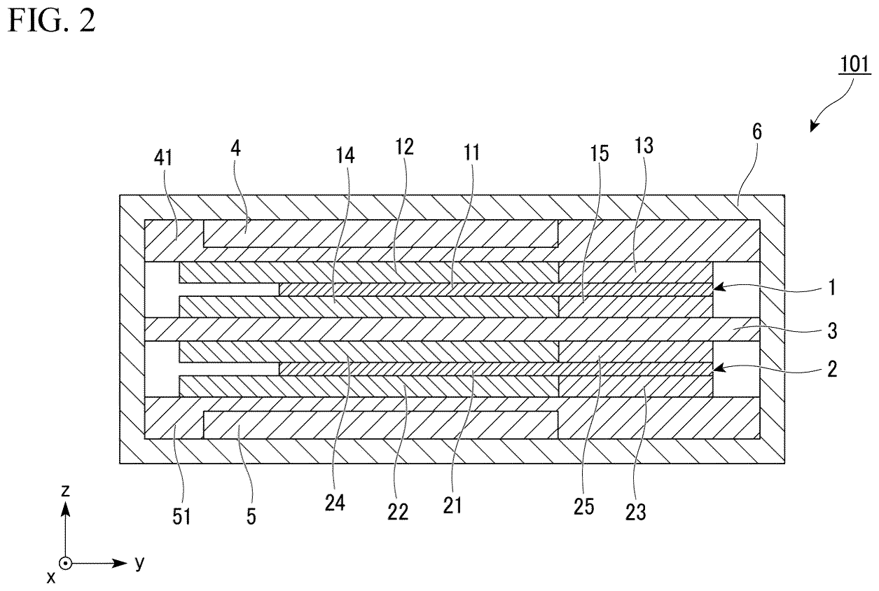

FIG. 2 is a cross-sectional view of the non-reciprocal circuit element 101 according to the first embodiment. FIG. 2 is a yz cross section taken along a center in the x direction of the non-reciprocal circuit element 101. The non-reciprocal circuit element 101 includes, for example, a first unit 1, a second unit 2, a ground conductor 3, a first magnet 4, a second magnet 5, and the housing 6. The first unit 1, the second unit 2, the ground conductor 3, the first magnet 4, and the second magnet 5 are housed in the housing 6. A non-reciprocal circuit element 100 functions, for example, as an isolator.

The first unit 1 has the conductor 11, a first magnetic body 12, a first absorbing body 13, a second magnetic body 14, and a second absorbing body 15. A layer including the first magnetic body 12 and the first absorbing body 13 is referred to as a first lossy layer and a layer including the second magnetic body 14 and the second absorbing body 15 is referred to as a second lossy layer.

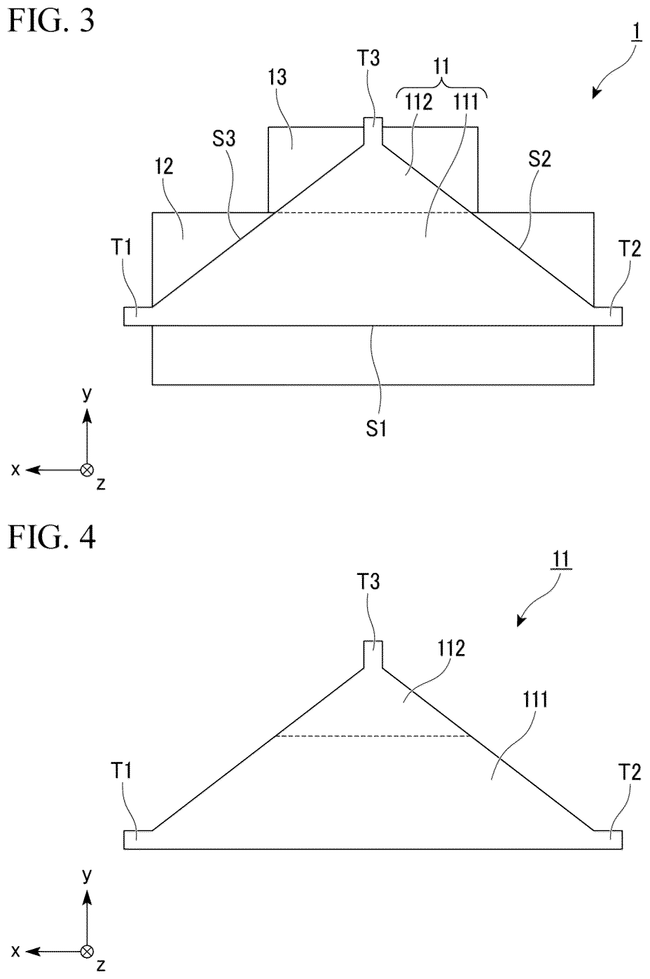

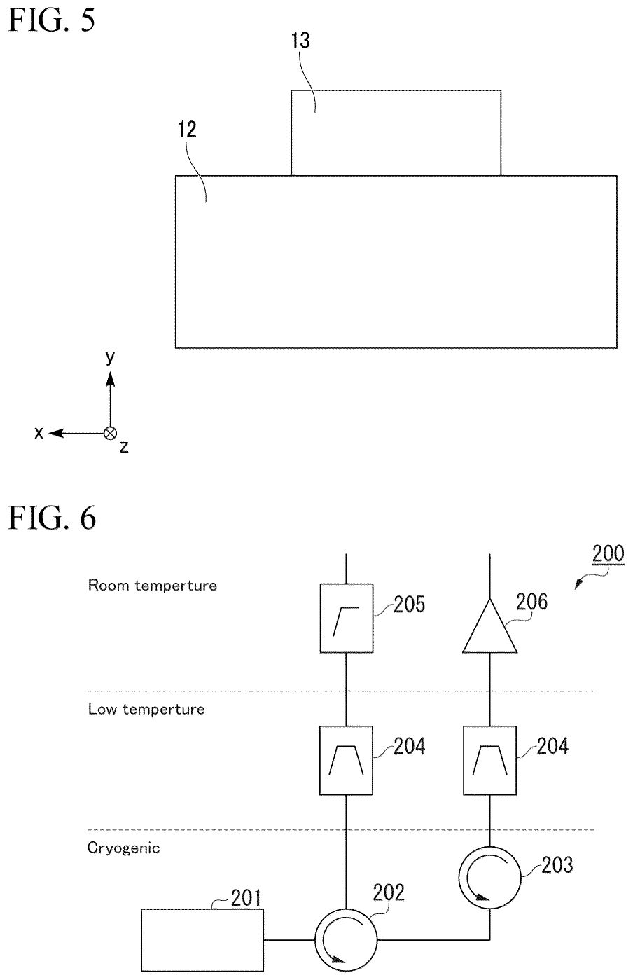

FIG. 3 is a plan view of the conductor 11 and the first lossy layer of the first unit 1. FIG. 4 is a plan view of the conductor 11 of the first unit 1. FIG. 5 is a plan view of the first lossy layer of the first unit 1.

The conductor 11 has the first terminal T1 and the second terminal T2. The conductor 11 may have a third terminal T3. The first terminal T1 is connected to the input terminal 61 and the second terminal T2 is connected to the output terminal 62. The third terminal T3 is, for example, an open end.

The conductor 11 transmits a high frequency signal. The conductor 11 transmits a high frequency signal non-reciprocally between the first terminal T1 and the second terminal T2. “Transmitting a high frequency signal non-reciprocally” means that the propagation efficiency of the signal is different in accordance with directions thereof. For example, when a signal propagates with little loss in a forward direction but barely propagates in a reverse direction, this corresponds to “transmitting a high frequency signal non-reciprocally.” A direction in which a high frequency signal in the conductor 11 propagates is controlled using the first lossy layer and the second lossy layer.

A high frequency signal input from the first terminal T1 is transmitted with low loss to the second terminal T2. Most of the high frequency signal input from the second terminal T2 is absorbed. Almost no high frequency signal is transmitted from the second terminal T2 to the first terminal T1. That is to say, a high frequency signal is transmitted with low loss from the first terminal T1 to the second terminal T2, but is hardly transmitted from the second terminal T2 to the first terminal T1.

There is no particular restriction on a type of conductor 11 as long as it can transmit a high frequency signal with high efficiency. The conductor 11 is made of, for example, aluminum, copper, silver, gold, stainless steel, or the like. The conductor 11 may be obtained by plating a non-conductor or a conductor with a high resistance value (such as phosphor bronze) with aluminum, copper, silver, gold, stainless steel, or the like.

The conductor 11 has a first region 111 and a second region 112. The conductor 11 may have regions other than the first region 111 and the second region 112. The first region 111 is a region in which the conductor 11 and the first magnetic body 12 overlap in the z direction. The first region 111 extends between the first terminal T1 and the second terminal T2. The second region 112 is a region in which the conductor 11 and the first absorbing body 13 overlap in the z direction. For example, a boundary between the first region 111 and the second region 112 and a boundary between the first magnetic body 12 and the first absorbing body 13 match when viewed from the z direction.

A shape of the conductor 11 in a plan view does not particularly matter. For example, as shown in FIG. 3, the shape of the conductor 11 in a plane view may be a triangle, a shape in which a side of a triangle may partially have an uneven shape, or each side of a triangle may be curved.

The first lossy layer and the second lossy layer have the conductor 11 disposed therebetween in the z direction. The first lossy layer includes the first magnetic body 12 and the first absorbing body 13. The second lossy layer includes the second magnetic body 14 and the second absorbing body 15. The first lossy layer and the second lossy layer have substantially the same shape and are symmetrical with respect to the conductor 11.

The first magnetic body 12 is located in a position different from that of the first absorbing body 13 in the same xy plane. The first magnetic body 12 is located in a position in which the first magnetic body 12 and the first region 111 of the conductor 11 overlap in the z direction. The first absorbing body 13 is located in a position in which the first absorbing body 13 and the second region 112 of the conductor 11 overlap in the z direction.

The second magnetic body 14 is located in a position different from that of the second absorbing body 15 in the same xy plane. The second magnetic body 14 is located in a position in which the second magnetic body 14 and the first region 111 of the conductor 11 overlap in the z direction. The second absorbing body 15 is located in a position in which the second absorbing body 15 and the second region 112 of the conductor 11 overlap in the z direction.

The first magnetic body 12 and the second magnetic body 14 have the first region 111 disposed therebetween in the z direction. The first absorbing body 13 and the second absorbing body 15 have the second region 112 disposed therebetween in the z direction.

As long as the first region 111 can be covered with the first magnetic body 12 and the second magnetic body 14, a shape of each thereof does not matter. As long as the second region 112 can be covered with the first absorbing body 13 and the second absorbing body 15, a shape of each thereof does not matter. For example, as shown in FIGS. 3 and 5, both the first magnetic body 12 and the first absorbing body 13 may have a rectangular shape when viewed from the z direction.

A high frequency signal passing through the conductor 11 propagates with a deviation to one side in a forward movement direction when a direct current (DC) magnetic field is applied to the first magnetic body 12 and the second magnetic body 14. For example, a high frequency signal input from the first terminal T1 deviates to the vicinity of a first side S1 and propagates along the first side S1 to the second terminal T2. On the other hand, a high frequency signal input to the second terminal T2 deviates to the vicinity of the second side S2 and the third side S3 and propagates along the second side S2 and the third side S3 to the first terminal T1. At this time, the high frequency signal input to the second terminal T2 is absorbed using the first absorbing body 13 and the second absorbing body 15 and is significantly attenuated.

The first magnetic body 12 and the second magnetic body 14 include a magnetic material. The first magnetic body 12 and the second magnetic body 14 may be formed of either a conductor or an insulator. The first magnetic body 12 and the second magnetic body 14 may, for example, have soft magnetic bodies. The first magnetic body 12 and the second magnetic body 14 include, for example, any one selected from the group consisting of Co-group amorphous, ferrite, Fe₈₅Si₂B₈P₄Cu, Fe₈₆AlB₈P₄Cu, Fe₇₈Si₉B₁₃, and yttrium iron garnet (YIG). YIG is, for example, Y₃Fe₂(FeO₄)₃ or Y₃Fe₅O₁₂.

The first magnetic body 12 and the second magnetic body 14 may be obtained by mixing magnetic particles with a resin. The magnetic particles include, for example, iron, silicon steel (Fe—Si), permalloy (Ni—Fe), permendur (Fe—Co), sendust (Fe—Si—Al), electromagnetic stainless steel, amorphous iron-based alloys (Fe—B—C-based, Fe—Co-based), manganese zinc ferrite, nickel zinc ferrite, and the like. The first magnetic body 12 and the second magnetic body 14 may be obtained by mixing ferrite particles with a resin.

When the magnetic material is dispersed in an insulating material (for example, resin, rubber, paint, or the like), a volume ratio of the magnetic material is preferably 10% or more and 70% or less. If a volume ratio of the magnetic material is small, an electromagnetic wave absorption ability thereof will be small. If a volume ratio of the magnetic material is large, it will be difficult to disperse the magnetic material into the insulating material.

The first absorbing body 13 and the second absorbing body 15 include a material which has a higher magnetic field loss rate than the first magnetic body 12 and the second magnetic body 14. The first absorbing body 13 and the second absorbing body 15 each include, for example, any material selected from the group consisting of iron, boron nitride (BN), conductive carbon, SiC, and Ni-based ferrite.

When the first lossy layer and the second lossy layer are conductors, an insulating layer is provided between the first lossy layer and the conductor 11 and between the second lossy layer and the conductor 11. Any known insulating layer can be used for the insulating layer.

The second unit 2 is located in a position in which the second unit 2 and the first unit 1 overlap in the z direction. The second unit 2 has a conductor 21, a first magnetic body 22, a first absorbing body 23, a second magnetic body 24, and a second absorbing body 25. A layer including the first magnetic body 22 and the first absorbing body 23 is referred to as a third lossy layer and a layer including the second magnetic body 24 and the second absorbing body 25 is referred to as a fourth lossy layer.

The conductor 21 has a constitution that is the same as that of the conductor 11 of the first unit 1. The first magnetic body 22 has a constitution that is the same as that of the first magnetic body 12 of the first unit 1. The first absorbing body 23 has a constitution that is the same as that of the first absorbing body 13 of the first unit 1. The second magnetic body 24 has a constitution that is the same as that of the second magnetic body 14 of the first unit 1. The second absorbing body 25 has a constitution that is the same as that of the second absorbing body 15 of the first unit 1. The first magnetic body 22 and the second magnetic body 24 have the first region of the conductor 21 disposed therebetween in the z direction and the first absorbing body 23 and the second absorbing body 25 have the second region of the conductor 21 disposed therebetween in the z direction.

The ground conductor 3 is located between the first unit 1 and the second unit 2 in the z direction. The ground conductor 3, for example, is in contact with each of the first unit 1 and the second unit 2. For example, the second lossy layer of the first unit 1 which includes the second magnetic body 14 and the second absorbing body 15 is in contact with the ground conductor 3. For example, the fourth lossy layer of the second unit 2 which includes the second magnetic body 24 and the second absorbing body 25 is in contact with the ground conductor 3.

The ground conductor 3 is connected to a reference potential, for example, via the housing 6. The reference potential is, for example, a ground. When the ground conductor 3 is connected to the reference potential, an electric field generated due to a current flowing through the conductor 11 is prevented from affecting the conductor 21. Similarly, when the ground conductor 3 is connected to the reference potential, the electric field generated due to the current flowing through the conductor 21 is prevented from affecting the conductor 11. In this way, a phenomenon in which a signal propagating in a certain conductor affects a signal propagating in another conductor is called crosstalk. The crosstalk is a source of noise in signals propagating in a conductor.

The ground conductor 3 is, for example, a non-magnetic body. When the ground conductor 3 is a non-magnetic body, it is possible to prevent a magnetic field between the first magnet 4 and the second magnet 5 from being blocked. The ground conductor 3 includes, for example, one or more elements selected from the group consisting of Au, Ag, Al, and Cu.

It is preferable that a film thickness of the ground conductor 3 satisfy, for example, the following Expression.

D=(2ρ/ωμ)^{1/2}

In the above Expression, d is a film thickness of the ground conductor 3, μ is the electrical resistivity of the conductor 11 or the conductor 21, ω is an angular frequency of a current flowing through the conductor 11 or the conductor 21, and μ is the magnetic permeability of the conductor 11 or the conductor 21. When the conductor 11 and the conductor 21 are made of different materials, a greater value of the electrical resistivity is assumed as ρ, a greater value of the angular frequency is assumed as ω, and a greater value of the magnetic permability is assumed as μ. If the ground conductor 3 satisfies the above relationship, the occurrence of crosstalk can be further prevented.

The first magnet 4 and the second magnet 5 have the first unit 1, the ground conductor 3, and the second unit 2 disposed therebetween in the z direction. The first magnet 4 and the second magnet 5 have the first magnetic body 12, the second magnetic body 14, the first magnetic body 22, and the second magnetic body 24 disposed therebetween in the z direction. The first magnet 4 and the second magnet 5 apply a DC magnetic field to the first magnetic body 12, the second magnetic body 14, the first magnetic body 22, and the second magnetic body 24. A part of each of the first magnet 4 and the second magnet 5 and the first absorbing body 13, the second absorbing body 15, the first absorbing body 23 and the second absorbing body 25 may overlap.

The first magnet 4 and the second magnet 5 are, for example, hard magnetic bodies. The first magnet 4 and the second magnet 5 may be either an insulating body or a conducting body. The first magnet 4 and the second magnet 5 include, for example, any one selected from the group consisting of a ferrite magnet having insulating properties, a rare earth magnet having electrical conductivity, TbFeCo, GdFeCo, SmFeCo, a [Co/Pt] multilayer film, and a [Co/Pd] multilayer film.

The first magnet 4 and the second magnet 5 are examples of magnetic field sources. The magnetic field sources are not limited to the first magnet 4 and the second magnet 5, as long as they can apply a DC magnetic field to the first magnetic body 12, the second magnetic body 14, the first magnetic body 22, and the second magnetic body 24

Between the first magnet 4 and the first unit 1, for example, a first ground body 41 is provided. When the first magnet 4 is a conducting body, the first ground body 41 may not be provided. Between the second magnet 5 and the second unit 2, for example, a second ground body 51 is provided. When the second magnet 5 is a conducting body, the second ground body 51 may not be provided. The first ground body 41 or the second ground body 51 is grounded to, for example, the reference potential. The reference potential is, for example, a ground. The first ground body 41 and the second ground body 51 may be made of any material as long as they are conductive.

The non-reciprocal circuit element 101 according to the first embodiment has excellent signal quality even when a plurality of units are integrated in a limited space in the housing 6. This is because the ground conductor 3 is located between the first unit 1 and the second unit 2. If the first unit 1 and the second unit 2 are housed in a narrow region, crosstalk in which the respective signals affect each other may occur in some cases. Crosstalk is a source of noise and is one of the causes of degradation in the quality of signals propagating in the unit. The non-reciprocal circuit element 101 according to the first embodiment has the ground conductor 3, and thus can prevent the occurrence of crosstalk and suppress degradation of signal quality. Furthermore, by suppressing the occurrence of crosstalk, the non-reciprocal circuit element 101 can be made smaller.

Also, in the non-reciprocal circuit element 101 according to the first embodiment, the magnet that applies a DC magnetic field to the first unit 1 and the magnet which applies a DC magnetic field to the second unit 2 are the first magnet 4 and the second magnet 5, respectively, and the first unit 1 shares the same magnet with the second unit 2. For this reason, the non-reciprocal circuit element 101 according to the first embodiment has a small number of parts and can be made compact.

The non-reciprocal circuit element 101 according to the embodiment can be applied to, for example, a quantum computer. FIG. 6 is a schematic diagram of a quantum computer according to the embodiment. A quantum computer 200 includes, for example, a quantum processor 201, non-reciprocal circuit elements 202 and 203, filters 204 and 205, and an amplifier 206.

The quantum processor 201 performs quantum calculation. The non-reciprocal circuit elements 202 and 203 deliver a readout signal of a quantum bit from the quantum processor 201. The non-reciprocal circuit element 202 is a circulator. The non-reciprocal circuit element 203 is an isolator. The non-reciprocal circuit element 101 according to the embodiment can be applied to the non-reciprocal circuit element 203. The amplifier 206 amplifies a readout signal.

For example, a superconducting quantum computer operates at an extremely low temperature. For this reason, the quantum processor 201 and the non-reciprocal circuit elements 202 and 203 are also disposed in positions in which they are exposed to an extremely low temperature environment. It is difficult to maintain a large volume of space in an extremely low temperature environment and reducing sizes of the non-reciprocal circuit elements 202 and 203 are required. The non-reciprocal circuit element 101 according to the embodiment has a small size and has excellent isolation characteristics, and is thus suitable for application to a quantum computer.

### Second Embodiment

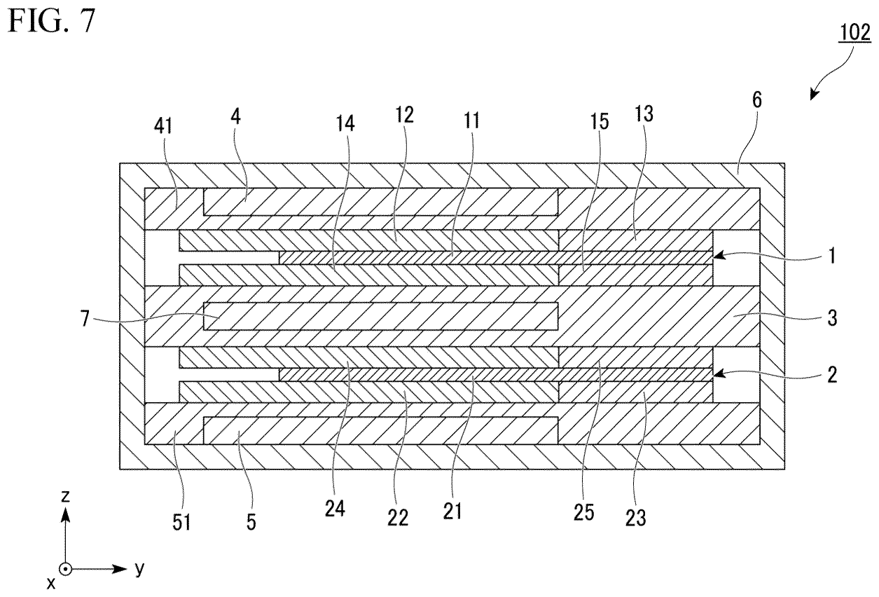

FIG. 7 is a cross-sectional view of a non-reciprocal circuit element 102 according to a second embodiment. FIG. 7 is a yz cross section taken along a center of the x direction of the non-reciprocal circuit element 102. The non-reciprocal circuit element 102 includes, for example, a first unit 1, a second unit 2, a ground conductor 3, a first magnet 4, a second magnet 5, a housing 6, and a third magnet 7. The non-reciprocal circuit element 102 according to the second embodiment differs from the non-reciprocal circuit element 101 according to the first embodiment in that it has the third magnet 7. In the non-reciprocal circuit element 102 according to the second embodiment, the same constituent elements as those in the non-reciprocal circuit element 101 according to the first embodiment are denoted by the same reference symbols and description thereof will be omitted.

The third magnet 7 is located inside the ground conductor 3. The third magnet 7 faces each of the first magnet 4 and the second magnet 5. The first magnet 4 and the third magnet 7 have the first magnetic body 12 and the second magnetic body 14 disposed therebetween in the z direction. The second magnet 5 and the third magnet 7 have the first magnetic body 22 and the second magnetic body 24 disposed therebetween in the z direction. The first magnet 4 and the third magnet 7 apply a DC magnetic field to the first magnetic body 12 and the second magnetic body 14. The second magnet 5 and the third magnet 7 apply a DC magnetic field to the first magnetic body 22 and the second magnetic body 24. A part of the third magnet 7 and the first absorbing body 13, the second absorbing body 15, the first absorbing body 23, and the second absorbing body 25 may overlap in the z direction. The third magnet 7 can be made of the same material as the first magnet 4 and the second magnet 5.

It is preferable that a film thickness between the second magnetic body 14 of the ground conductor 3 and the third magnet 7 satisfy a relation expression of d=(2ρ/ωμ)^{1/2}. In this case, d is a film thickness between the second magnetic body 14 of the ground conductor 3 and the third magnet 7, ρ is the electrical resistivity of the conductor 11, ω is an angular frequency of a current flowing through the conductor 11, and μ is the magnetic permability of the conductor 11. Similarly, it is preferable that a film thickness between the second magnetic body 24 of the ground conductor 3 and the third magnet 7 satisfy a relation expression d=(2ρ/ωμ)^{1/2}. In this case, dis a film thickness between the second magnetic body 24 of the ground conductor 3 and the third magnet 7, ρ is the electrical resistivity of the conductor 21, @ is an angular frequency of a current flowing through the conductor 21, and μ is the magnetic permability of the conductor 21.

The non-reciprocal circuit element 102 according to the second embodiment has the ground conductor 3 between the first unit 1 and the second unit 2, and thus has excellent signal quality. Furthermore, in the non-reciprocal circuit element 102 according to the second embodiment, different magnetic fields can be applied to the first unit 1 and the second unit 2, and thus the first unit 1 and the second unit 2 can function independently.

### Third Embodiment

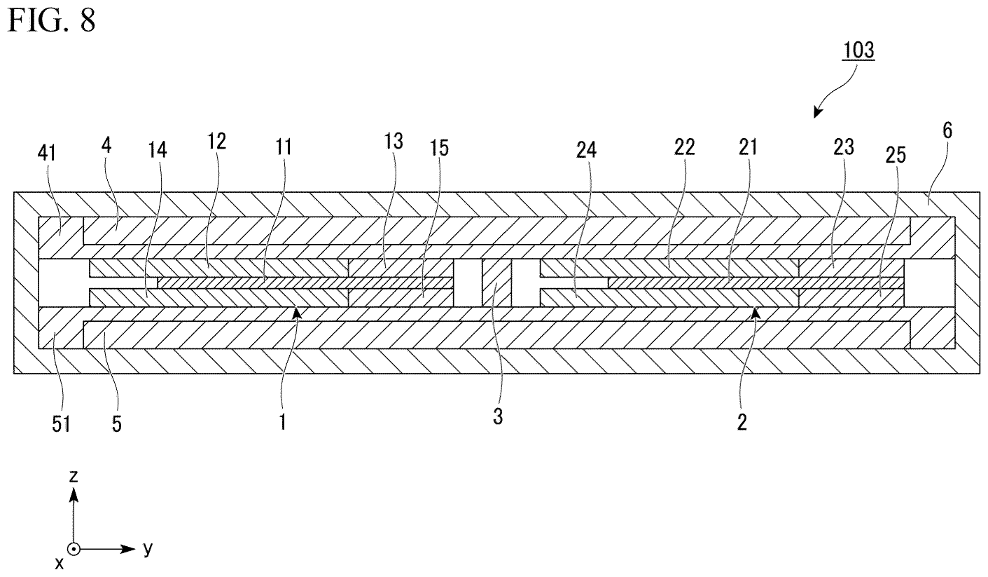

FIG. 8 is a cross-sectional view of a non-reciprocal circuit element 103 according to a third embodiment. FIG. 8 is a yz cross section taken along a center of the x direction of the non-reciprocal circuit element 103. The non-reciprocal circuit element 102 includes, for example, a first unit 1, a second unit 2, a ground conductor 3, a first magnet 4, a second magnet 5, and a housing 6. The non-reciprocal circuit element 103 according to the third embodiment differs from the non-reciprocal circuit element 101 according to the first embodiment in that the first unit 1 and the second unit 2 do not overlap in the z direction. In the non-reciprocal circuit element 103 according to the third embodiment, the same constituent elements as those in the non-reciprocal circuit element 101 according to the first embodiment are denoted by the same reference symbols and description thereof will be omitted.

The ground conductor 3 is located between the first unit 1 and the second unit 2. The ground conductor 3 is located between the first unit 1 and the second unit 2 in the x direction. Each of the conductor 11 and the conductor 21 is spaced apart from the ground conductor 3.

The ground conductor 3 may be, for example, a non-magnetic body or a magnetic body. It is preferable that the ground conductor 3 be a non-magnetic body.

The first magnet 4 and the second magnet 5 have the first unit 1, the ground conductor 3, and the second unit 2 disposed therebetween in the z direction. Each of the first magnet 4 and the second magnet 5 extends across the first unit 1 and the second unit 2. The first magnet 4 and the second magnet 5 apply a DC magnetic field to each of the first magnetic body 12, the second magnetic body 14, and the first magnetic body 22 and the second magnetic body 24.

The non-reciprocal circuit element 103 according to the third embodiment has the ground conductor 3 between the first unit 1 and the second unit 2, and thus has excellent signal quality. Furthermore, in the non-reciprocal circuit element 103 according to the third embodiment, the first unit 1 shares a magnet with the second unit 2, and thus the number of parts is reduced, enabling miniaturization.

### Fourth Embodiment

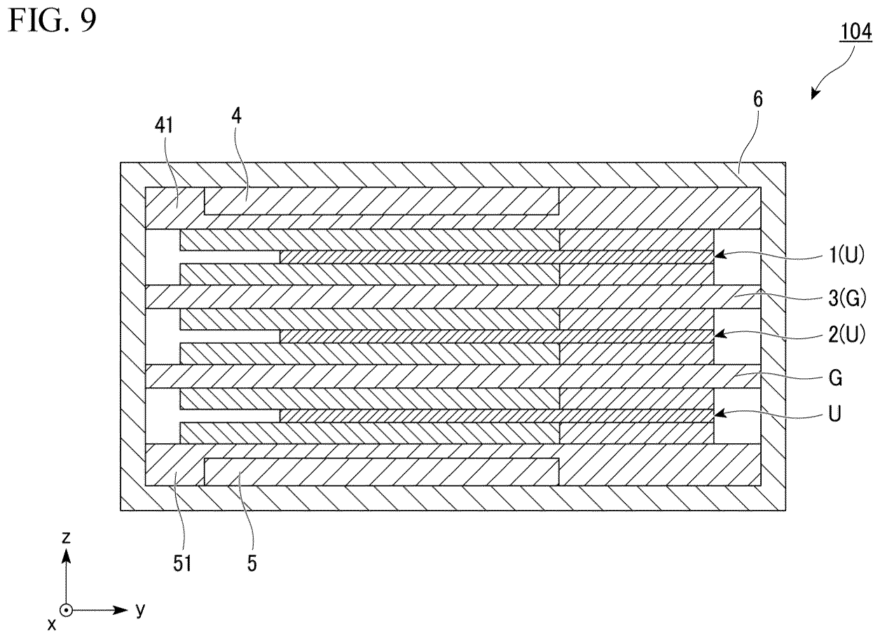

FIG. 9 is a cross-sectional view of a non-reciprocal circuit element 104 according to a fourth embodiment. FIG. 9 is a yz cross section taken along a center of the x direction of the non-reciprocal circuit element 104. The non-reciprocal circuit element 104 includes a plurality of units U, a plurality of ground conductors G, a first magnet 4, a second magnet 5, and a housing 6. The non-reciprocal circuit element 104 according to the fourth embodiment differs from the non-reciprocal circuit element 101 according to the first embodiment in that the number of units U is three. In the non-reciprocal circuit element 104 according to the fourth embodiment, the same constituent elements as those in the non-reciprocal circuit element 101 according to the first embodiment are denoted by the same reference symbols and description thereof will be omitted.

Each of the units U has a configuration that is the same as that of the first unit 1 or the second unit 2. One of the plurality of units U is the first unit 1 and another thereof is the second unit 2. Each of the ground conductors G has a configuration that is the same as that of the ground conductor 3. One of the plurality of ground conductors G is the ground conductor 3. Each of the ground conductors G is located between neighboring units of the units U.

The non-reciprocal circuit element 104 according to the fourth embodiment only differs in the number of units and has the same effects as the non-reciprocal circuit element 101 according to the first embodiment. Furthermore, here, although an example in which there are three units has been shown, the number of units is not limited to this case and may be four or more.

### Fifth Embodiment

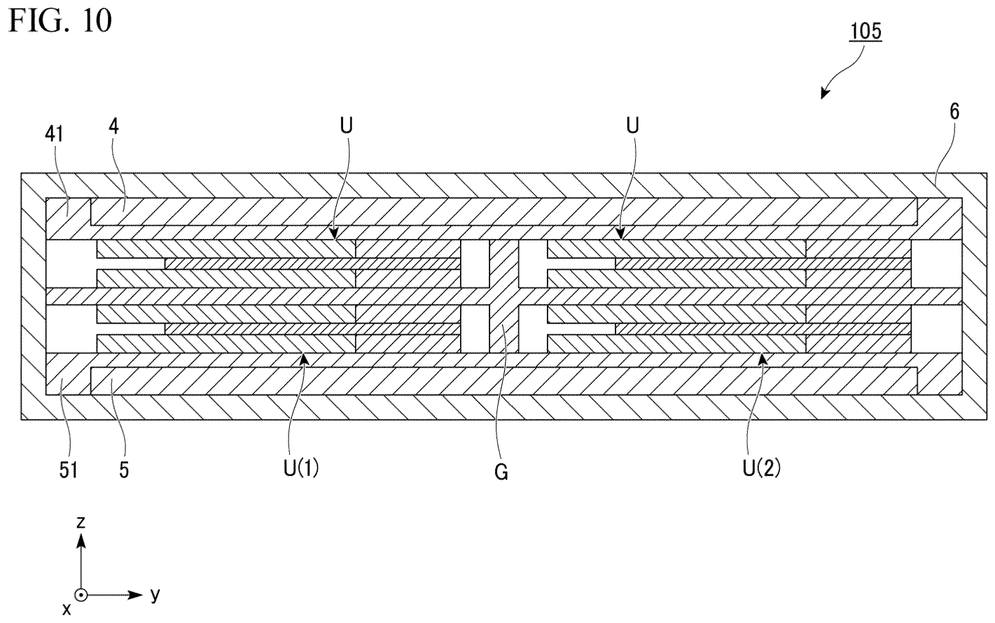

FIG. 10 is a cross-sectional view of a non-reciprocal circuit element 105 according to a fifth embodiment. FIG. 10 is a yz cross section taken along a center of the x direction of the non-reciprocal circuit element 105. The non-reciprocal circuit element 105 includes a plurality of units U, a ground conductor G, a first magnet 4, a second magnet 5, and a housing 6. The non-reciprocal circuit element 105 according to the fifth embodiment differs from the non-reciprocal circuit element 101 according to the first embodiment in that the number of unit U is four. In the non-reciprocal circuit element 105 according to the fifth embodiment, the same constituent elements as those in the non-reciprocal circuit element 101 according to the first embodiment are denoted by similar reference symbols and descriptions thereof will be omitted.

The non-reciprocal circuit element 105 according to the fifth embodiment has the plurality of units U. Each of the units U has a configuration that is the same as that of the first unit 1 or the second unit 2. One of the plurality of units U is the first unit 1 and another thereof is the second unit 2. The ground conductor G is located between the units U. The ground conductor G has a configuration that is the same as that of the ground conductor 3.

Like the non-reciprocal circuit element 105 according to the fifth embodiment, the units U may be combined with elements arranged in the same plane and elements stacked in the stacking direction. The non-reciprocal circuit element 105 according to the fifth embodiment only differs in the number of units and has the same effect as the non-reciprocal circuit element 101 according to the first embodiment. The number of units in the non-reciprocal circuit element 105 according to the fifth embodiment does not matter and the number of units arranged in the xy plane and the number of units stacked in the z direction also do not matter.

### Sixth Embodiment

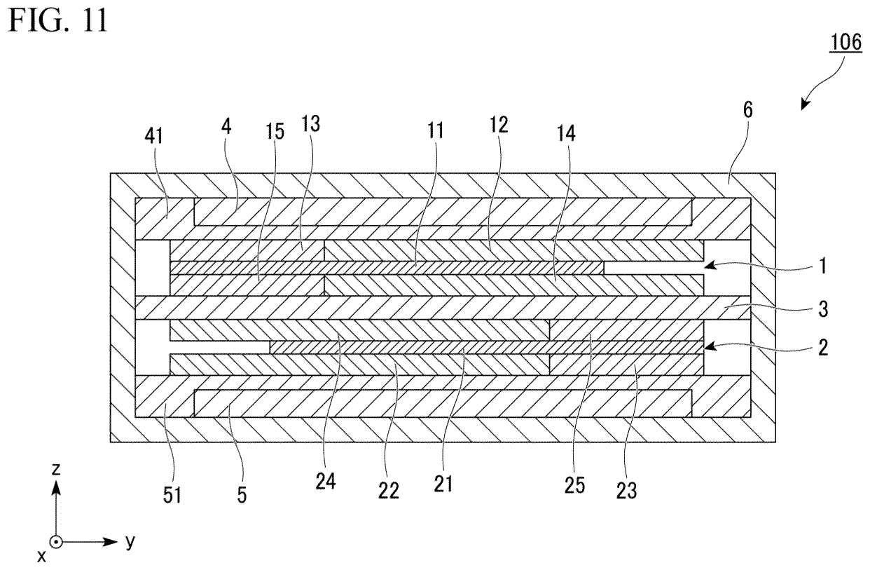

FIG. 11 is a cross-sectional view of a non-reciprocal circuit element 106 according to a sixth embodiment. FIG. 11 is a yz cross section taken along a center of the x direction of the non-reciprocal circuit element 106. The non-reciprocal circuit element 106 differs from the non-reciprocal circuit element 101 according to the first embodiment in that a direction of the first unit 1 is different. In the non-reciprocal circuit element 106 according to the sixth embodiment, the same constituent elements as those in the non-reciprocal circuit element 101 according to the first embodiment are denoted by similar reference symbols and descriptions thereof will be omitted.

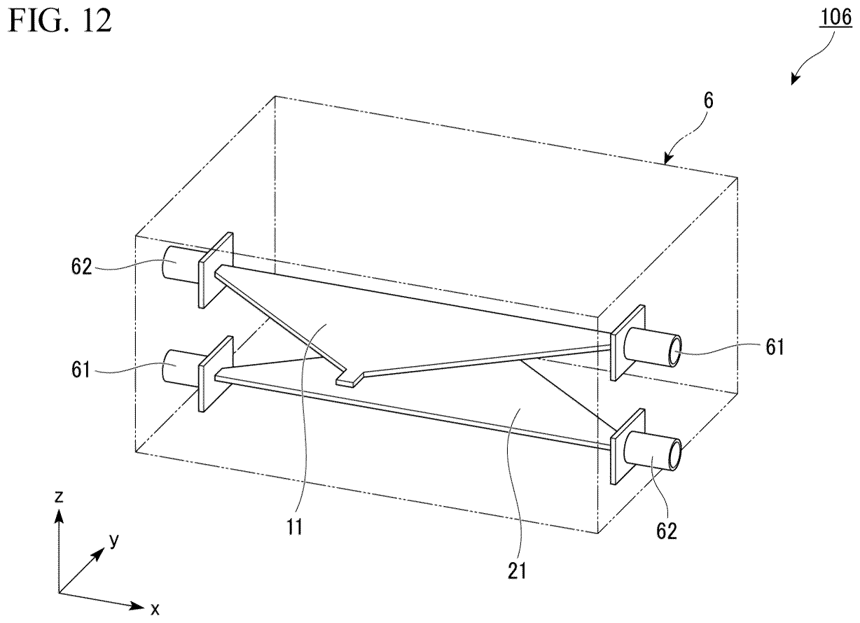

FIG. 12 is a perspective view of the non-reciprocal circuit element 106 according to the sixth embodiment. In the non-reciprocal circuit element 106 according to the sixth embodiment, a third terminal T3 in the first unit 1 faces the −y direction and a third terminal T3 in the second unit 2 faces the +y direction. In this case, as shown in FIG. 12, an input terminal 61 of the first unit 1 is installed in a surface that is different from that of an input terminal 61 of the second unit 2. Similarly, in this case, an output terminal 62 of the first unit 1 is installed in a surface that is different from that of an output terminal 62 of the second unit 2.

The non-reciprocal circuit element 106 according to the sixth embodiment only differs in the direction of the units and has the same effect as the non-reciprocal circuit element 101 according to the first embodiment. In the non-reciprocal circuit element 106 of the sixth embodiment, the output terminal 62 of the first unit 1 and the input terminal 61 of the second unit 2 are disposed on the same surface of the housing 6, making it easy to connect the first unit 1 and the second unit 2 in series.

### Seventh Embodiment

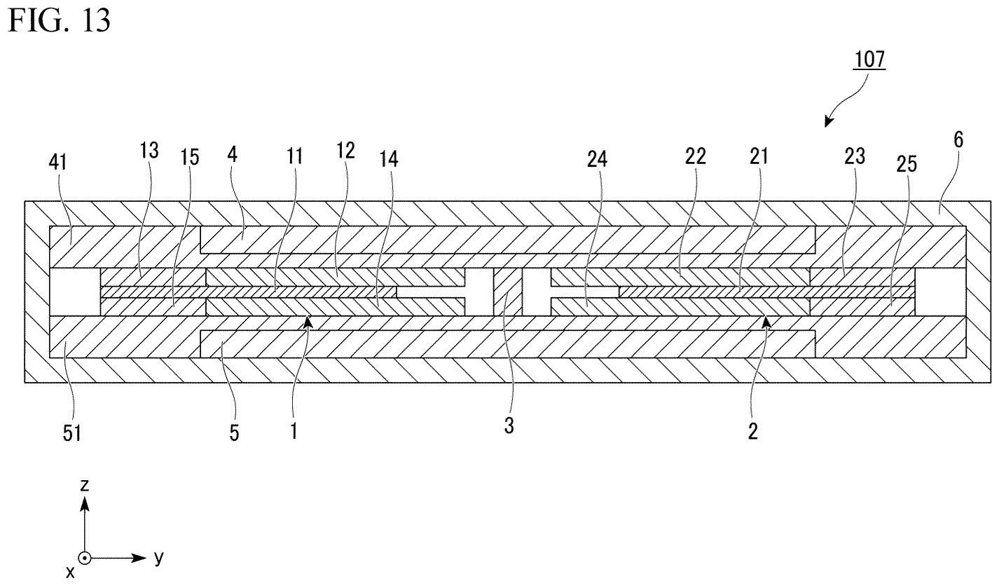

FIG. 13 is a cross-sectional view of a non-reciprocal circuit element 107 according to a seventh embodiment. FIG. 13 is a yz cross section taken along a center of the x direction of the non-reciprocal circuit element 107. The non-reciprocal circuit element 107 differs from the non-reciprocal circuit element 103 according to the third embodiment in that the direction of the first unit 1 is different. In the non-reciprocal circuit element 107 according to the seventh embodiment, the same constituent elements as those in the non-reciprocal circuit element 103 according to the third embodiment are denoted by the same reference symbols and description thereof will be omitted.

Even when each of the units is disposed in an in-plane direction, a direction of each of the units does not particularly matter, as in the sixth embodiment. Neighboring units may be disposed so that third terminals of the adjacent units face each other or vice versa (refer to FIG. 13).

The non-reciprocal circuit element 107 according to the seventh embodiment differs only in the direction of the units and has the same effect as the non-reciprocal circuit element 103 according to the third embodiment. When first magnetic bodies 12 of adjacent units are disposed closer to the ground conductor 3 as in the non-reciprocal circuit element 107 shown in FIG. 13, sizes of the first magnet 4 and the second magnet 5 can be reduced.

### Eighth Embodiment

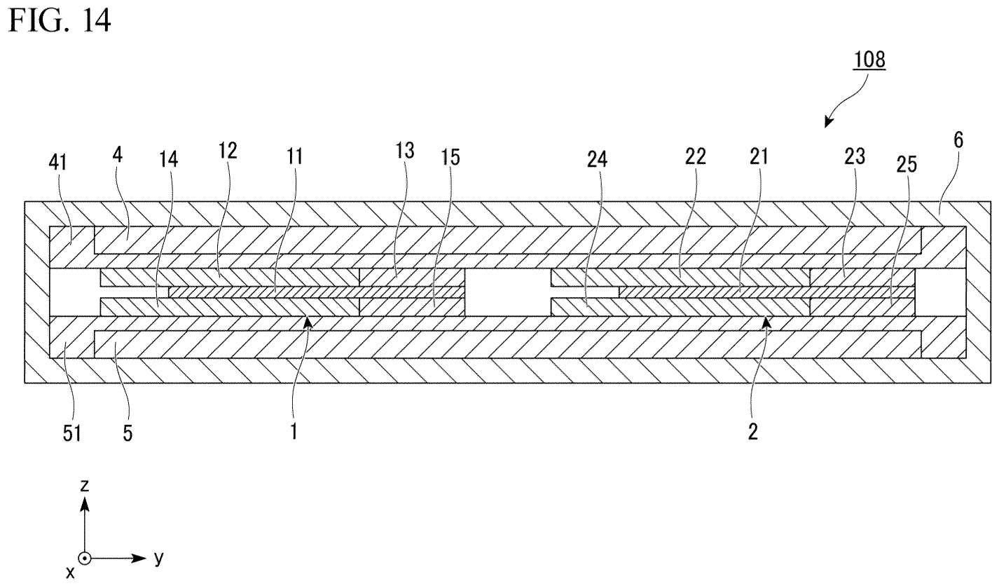

FIG. 14 is a cross-sectional view of a non-reciprocal circuit element 108 according to an eighth embodiment. FIG. 14 is a yz cross section taken along a center of the x direction of the non-reciprocal circuit element 108. The non-reciprocal circuit element 108 includes, for example, a first unit 1, a second unit 2, a first magnet 4, a second magnet 5, and a housing 6. The non-reciprocal circuit element 108 differs from the non-reciprocal circuit element 103 according to the third embodiment in that the non-reciprocal circuit element 108 does not have the ground conductor 3. In the non-reciprocal circuit element 108 according to the eighth embodiment, the same constituent elements as those in the non-reciprocal circuit element 103 according to the third embodiment are denoted by the same reference numerals and description thereof will be omitted.

The first unit 1 and the second unit 2 are located at different positions in the xy plane. The first unit 1 and the second unit 2 are located sufficiently far apart that the electric field generated by the first unit 1 has little effect on the second unit 2. A position which is sufficiently distant so that an electric field generated in the first unit 1 has almost no effect on the second unit 2 is, for example, 2 mm or more. If the first unit 1 and the second unit 2 are far sufficient apart, a current flowing through each one has only a negligible effect on the other unit. For this reason, in this case, the ground conductor 3 may be removed.

In the non-reciprocal circuit element 108 according to the eighth embodiment, the first unit 1 and the second unit 2 are sufficiently far apart and crosstalk can be sufficiently suppressed so that an excellent signal quality is provided. Furthermore, in the non-reciprocal circuit element 108 according to the eighth embodiment, since the first unit 1 shares a magnet with the second unit 2 and the ground conductor 3 does not need to be provided, the number of parts is reduced.

Although an example of the first embodiment has been shown above, the present disclosure is not limited to these embodiments and various modifications are possible. For example, characteristic configurations of the respective embodiments may be combined.

### EXPLANATION OF REFERENCES

1 First unit
2 Second unit
3 Ground conductor
4 First magnet
5 Second magnet
6 Housing
7 Third magnet
11, 21 Conductor
12, 22 First magnetic body
13, 23 First absorbing body
14, 24 Second magnetic body
15, 25 Second absorbing body
41 First ground body
51 Second ground body
61 Input terminal
62 Output terminal
101, 102, 103, 104, 105, 106, 107, 108 Non-reciprocal circuit element
111 First region
112 Second region
200 Quantum computer
201 Quantum processor
202, 203 Non-reciprocal circuit element
204, 205 Filter
206 Amplifier
G Ground conductor
S1 First side
S2 Second side
S3 Third side
T1 First terminal
T2 Second terminal
T3 Third terminal
U Unit

What is claimed is:

1. A non-reciprocal circuit element, comprising:
a housing, a first unit, a second unit, a ground conductor, a first magnet, and a second magnet,
wherein the first unit, the second unit, the ground conductor, the first magnet, and the second magnet are housed in the housing,
the ground conductor is located between the first unit and the second unit,
the first magnet and the second magnet have the first unit, the ground conductor, and the second unit disposed therebetween,
each of the first unit and the second unit includes a conductor, a first magnetic body, a first absorbing body, a second magnetic body, and a second absorbing body,
the conductor has a first terminal and a second terminal, and
in each of the first unit and the second unit, a first region of conductor which extends between the first terminal and the second terminal is sandwiched between the first magnetic body and the second magnetic body and a second region which is different from the first region of the conductor is sandwiched between the first absorbing body and the second absorbing body.

2. The non-reciprocal circuit element according to claim 1, wherein the ground conductor is a non-magnetic body.

3. The non-reciprocal circuit element according to claim 1, wherein a film thickness of the ground conductor satisfies the following expression:
d=(2ρ/ωμ)^{1/2}, and
in the above expression, d is a film thickness of the ground conductor, ρ is the electrical resistivity of the conductor, ω is an angular frequency of a current flowing through the conductor, and μ is the magnetic permeability of the conductor.

4. The non-reciprocal circuit element according to claim 1, further comprising:
a third magnet,
wherein the third magnet is located inside the ground conductor, and
the third magnet faces the first magnet and the second magnet.

5. The non-reciprocal circuit element according to claim 1, wherein the first unit is located at a position in which the first unit and the second unit overlap in a stacking direction.

6. The non-reciprocal circuit element according to claim 1, wherein the first unit and the second unit do not overlap in a stacking direction.

7. A quantum computer, comprising:
the non-reciprocal circuit element according to claim 1.
